(19) United States
(12) Patent Application Publication
(10) Pub. No.: US 2025/0173651 A1
(43) Pub. Date: May 29, 2025

(54) ELECTRONIC IDENTIFICATION CODE SCANNER FOR TRACKING SUPPLY CHAIN TRANSACTION INFORMATION BASED ON NO-CODE AND CONTROL METHOD THEREOF

(71) Applicant: YYSOFT CO., LTD., Gyeonggi-do (KR)

(72) Inventors: HONG HYUN YANG, Gyeonggi-do (KR); SUNG YEOL CHOI, Gangwon-do (KR)

(21) Appl. No.: 18/962,369

(22) Filed: Nov. 27, 2024

(30) Foreign Application Priority Data
Nov. 28, 2023 (KR) 10-2023-0168117

(51) Int. Cl. G06Q 10/0631

(52) U.S. Cl. CPC G06Q 10/06315

(57) ABSTRACT

An electronic identification code scanner includes a memory that store logistics environment information in advance, a GPS module that receives GPS information, a scan sensor that scans an electronic identification code, a processor that identifies event information corresponding to the scanned electronic identification code and converts the event information into a predetermined standardized format for supply chain transaction information, the standardized format including object information, time information, location information and purpose information, and a communication that transmits the event information having the standardized format.

### CROSS-REFERENCE TO RELATED APPLICATION

This application claims priority to and the benefit of Korean Patent Application No. 10-2023-0168117, filed on Nov. 28, 2023, the disclosure of which is incorporated herein by reference in its entirety.

### BACKGROUND

### 1. Field of the Invention

The present disclosure relates to a device and method for tracking supply chain transaction information on a no-code basis, and more specifically, to an electronic identification code scanner that converts event information scanned by a scan sensor into a standardized format for supply chain transaction information and a control method thereof.

### 2. Discussion of Related Art

The world is working together to build a smart distribution logistics ecosystem through standardized digital transformation with sustainability as the goal. Global Standards 1 (GS1), which is the non-profit international standards organization for distribution and logistics around the world, is at the center of building the smart distribution logistics ecosystem.

GS1 is developing tracking standards and guidelines for rail and sea transportation, and air logistics to improve visibility in history tracking and meet consumer satisfaction in distribution and logistics, and the tracking standards and guidelines can be applied to agricultural products as well as industrial products.

In addition, the ultimate goal of GS1 is to establish documents on standards that enable implementation of history tracking on existing GS1 standards such as a GS1 identification system, 1- and 2-dimensional barcodes, radio frequency identification (RFID), EPCIS & Core Business Vocabulary (CBV), Electronic Data Interchange (EDI), and Global Data Synchronization Network (GDSN), as well as implementation guidelines for various industrial fields.

This GS1 international standard is a standard that will best realize the data industry, which is the core of the 4th industrial revolution era, and its breadth is expanding to include not only transportation and logistics, but also distribution, healthcare, smart factories, and national defense.

Recently, a demand for product trackability has been increasing in various industries for consumer safety.

Therefore, there is a need to develop a technology for recording and managing various types of information generated during a manufacturing and/or distribution process of a product as a history, thereby enabling not only players involved in the manufacturing and/or distribution process, but also consumers who consume the product to quickly and accurately track the history.

Examples of the related art include Korean Registered Patent Publication No. 10-1451683 (Registration Date: Oct. 10, 2014).

### SUMMARY OF THE INVENTION

The present disclosure provides an electronic identification code scanner which converts event information scanned by a scan sensor into a predetermined standardized format for supply chain transaction information, and a control method thereof.

The problems to be solved by the present disclosure are not limited to the problems mentioned above, and other problems that are not mentioned will be clearly understood by those skilled in the art from the description below.

According to an aspect of the present disclosure, an electronic identification code scanner includes a memory that store logistics environment information in advance, a GPS module that receives GPS information, a scan sensor that scans an electronic identification code, a processor that identifies event information corresponding to the scanned electronic identification code and converts the event information into a predetermined standardized format for supply chain transaction information, the standardized format including object information, time information, location information and purpose information, and a communication that transmits the event information having the standardized format, wherein the logistics environment information includes an event type (EPCIS EVENT TYPE) indicating a change in a specific variable or state, a business step (EPCIS Biz-Step) indicating a specific step or state in a business process, and a location period indicating a period of time during which a product stays at a specific location, and the processor is configured to obtain the object information from the identified event information, obtain the time information and the location information from the GPS information, and generate an event indicating a change in a variable from a Core Business Vocabulary (CBV), based on the business step whenever a value of the variable changes according to a predetermined condition, using the business step indicating the specific step or state in the business process among the logistics environment information to obtain the purpose information indicating at which business step in the business process the value of the variable has changed for the generated event, the value of the variable being determined by the event type.

In an embodiment, the purpose information may include at least one of a Business step representing a specific activity or task in a business process; a Disposition representing a disposition or decision about an asset or resource; a Business Transaction List representing a list of transactions that have occurred in the business; a Source List representing a list associated with resources, materials, or suppliers needed in the business; and a Destination List representing a location or destination to which a product, service, or resource is being moved or delivered in the business process.

In an embodiment, the processor may transmit the event information, which has converted into the standardized format to the tracking device by inputting the event information into a separate platform or app for providing a supply chain transaction information tracking service, and the tracking device may receive the event information and generate a map for tracking a manufacturing or distribution process for a specific product by reflecting the event information in a supply chain scenario related to the specific product among a plurality of supply chain scenarios.

According to an aspect of the present disclosure, a control method of an electronic identification code scanner, the control method being performed by the electronic identification code scanner, includes storing, in a memory, logistics environment information including an event type (EPCIS EVENT TYPE) indicating a change in a specific variable or state, a business step (EPCIS Biz-Step) indicating a specific step or state in a business process, and a location period indicating a period of time during which a product stays at a specific location, receiving GPS information, scanning an electronic identification code, identifying event information corresponding to the scanned electronic identification code, converting the event information into a predetermined standardized format for supply chain transaction information, the standardized format including object information, time information, location information and purpose information, and transmitting the event information having the standardized format, wherein the converting of the event information into the predetermined standardized format for supply chain transaction information includes obtaining the object information from the identified event information, obtaining the time information and the location information from the GPS information, and generating an event indicating a change in a variable from a Core Business Vocabulary (CBV), based on the business step whenever a value of the variable changes according to a predetermined condition, using the business step indicating the specific step or state in the business process among the logistics environment information to obtain the purpose information indicating at which business step in the business process the value of the variable has changed for the generated event, the value of the variable being determined by the event type.

In an embodiment, the control method may further include transmitting the event information, which has converted into the standardized format to the tracking device by inputting the event information into a separate platform or app for providing a supply chain transaction information tracking service. The tracking device may receive the event information and generate a map for tracking a manufacturing or distribution process for a specific product by reflecting the event information in a supply chain scenario related to the specific product among a plurality of supply chain scenarios.

According to still another aspect of the present disclosure, there is further provided a computer program that is stored in a computer-readable recording medium for causing the method for implementing the present disclosure to be executed.

According to yet another aspect of the present disclosure, there is further provided a computer-readable recording medium that records the computer program for causing the method for implementing the present disclosure to be executed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a structure of an Electronic Product Code (EPC) global network according to an embodiment of the present disclosure;

FIG. 2 is a diagram showing a network structure of a system for tracking supply chain transaction information based on the EPC global network according to an embodiment of the present disclosure;

FIG. 3 is a flowchart showing an operation of the system for tracking supply chain transaction information according to an embodiment of the present disclosure;

FIG. 4 is a diagram showing a configuration of an electronic identification code scanner for tracking supply chain transaction information according to an embodiment of the present disclosure;

FIG. 5 is a diagram of describing a standardized format for supply chain transaction information according to an embodiment of the present disclosure;

FIG. 6 is a flow chart of a control method of an electronic identification code scanner according to an embodiment of the present disclosure; and

FIG. 7 is a diagram showing an example of a supply chain scenario according to an embodiment of the present disclosure.

### DETAILED DESCRIPTION OF EXEMPLARY EMBODIMENTS

Hereinafter, embodiments disclosed in this specification will be described in detail with reference to the accompanying drawings, while giving identical or similar components the same reference numbers throughout the drawings and omitting redundant descriptions thereof. The words “module” and “unit” used for components in the following description are given or used interchangeably only for the convenience of writing the specification, and do not have distinct meanings or roles in themselves. In addition, in describing embodiments disclosed in this specification, when it is determined that a specific description of a related known technology may obscure the gist of the embodiments disclosed in this specification, the detailed description thereof will be omitted. In addition, the accompanying drawings are only intended to facilitate easy understanding of the embodiments disclosed in this specification, and the technical ideas disclosed in this specification are not limited by the accompanying drawings, and should be understood to include all modifications, equivalents, and substitutes included in the spirit and technical scope of this disclosure.

Hereinafter, embodiments disclosed in this specification will be described in detail with reference to the accompanying drawings, while giving identical or similar components the same reference numbers throughout the drawings and omitting redundant descriptions thereof. The words “module” and “unit” used for components in the following description are given or used interchangeably only for the convenience of writing the specification, and do not have distinct meanings or roles in themselves. In addition, in describing embodiments disclosed in this specification, when it is determined that a specific description of a related known technology may obscure the gist of the embodiments disclosed in this specification, the detailed description thereof will be omitted. In addition, the accompanying drawings are only intended to facilitate easy understanding of the embodiments disclosed in this specification, and the technical ideas disclosed in this specification are not limited by the accompanying drawings, and should be understood to include all modifications, equivalents, and substitutes included in the spirit and technical scope of this disclosure.

Terms including ordinal numbers such as “first,” “second,” etc. may be used to describe various components, but the components are not limited by the terms. The terms are used only for the purpose of distinguishing one component from another component.

When a component is “connected” or “coupled” to another component, it should be understood that the component may be directly connected or coupled to the other component, or another component may be disposed therebetween. On the other hand, when a component is “directly connected” or “directly coupled” to another component, it should be understood that there are no other components therebetween.

In the present application, the terms “include” and “have” are intended to specify the presence of a feature, number, step, operation, component, part, or combination thereof described in the specification, but should be understood not to preclude the presence or addition of one or more other features, numbers, steps, operations, components, parts, or combinations thereof.

In this specification, the term “unit” includes a unit realized by hardware, a unit realized by software, and a unit realized using both. In addition, one unit may be realized by using two or more pieces of hardware, and two or more units may be realized by one piece of hardware.

Some of the operations or functions described as being performed by a terminal, apparatus, or device in this specification may instead be performed by a server connected to the terminal, apparatus, or device. Similarly, some of the operations or functions described as being performed by a server may also be performed by a terminal, apparatus, or device connected to the server.

Although the description in this specification is limited to “a device 100 for tracking supply chain transaction information,” the device is a terminal intended to provide a supply chain transaction information tracking service that enables tracking of a manufacturing or distribution process of a specific product based on a separate platform, and may include various devices capable of performing computational processing. That is, the device 100 for tracking supply chain transaction information may further include a server, a computer, and/or a portable terminal, or may be in the form of any one of a server, a computer, and/or a portable terminal, but is not limited thereto. However, for the convenience of description, the description will be limited to a case where the device 100 for tracking supply chain transaction information is based on a separate platform built to support the supply chain transaction information tracking service. To this end, a separate application or web page may be provided.

Here, examples of the computer may include a notebook, a desktop, a laptop, a tablet PC, a slate PC, etc. equipped with a web browser.

The server is a server that processes information by communicating with an external device, and may include an application server, a computing server, a database server, a file server, a game server, a mail server, a proxy server, a web server, or the like.

The portable terminal is, for example, a wireless communication device that ensures portability and mobility, and may include all kinds of handheld-based wireless communication devices such as Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, Wideband-CDMA (W-CDMA), and Wireless Broadband Internet (WiBro) terminals, smart phones, etc., and wearable devices such as watches, rings, bracelets, anklets, necklaces, glasses, contact lenses, or head-mounted devices (HMDs).

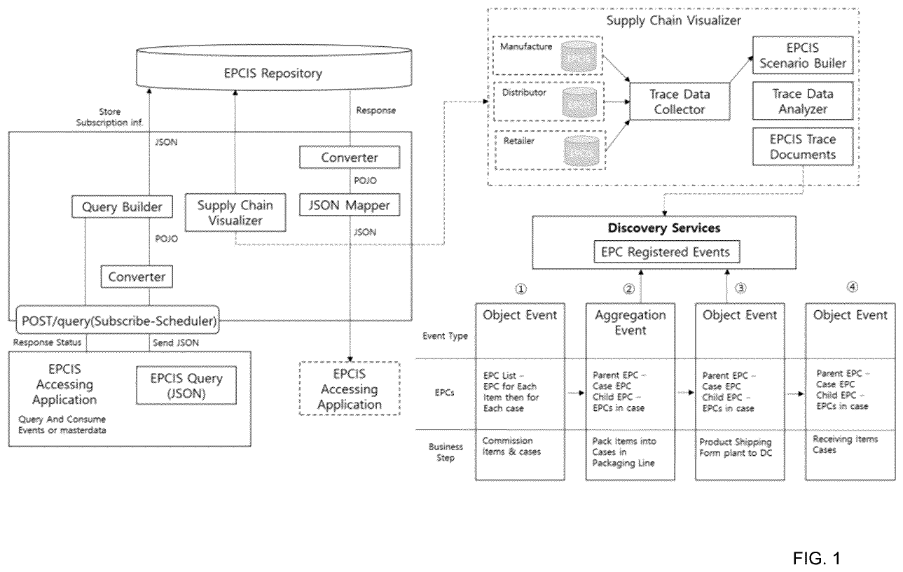

FIG. 1 is a diagram showing a structure of an Electronic Product Code (EPC) global network according to an embodiment of the present disclosure.

Looking at the EPC global network with reference to FIG. 1, the EPC global network is used to allow a product and object to be automatically identified using electronic identification codes such as a radio frequency identification (RFID) tag equipped with the EPC and a reader that can recognize the RFID tag, identified information to be shared through a network such as the Internet, and a location of the product to be tracked, thereby enabling global supply chain management.

Data generated in the EPC global network is primarily provided to stakeholders who need the information and is stored in EPC Information Services (EPCIS) Repository in order to check data.

Among components of an EPCIS system, the EPCIS Repository, which continuously stores and manages a large amount of EPCIS event information (data) input from devices such as numerous RFID terminals at the same time, stores the corresponding EPCIS event information in a database for continuous processing of the large amount of data when multiple processes access the EPCIS Repository at the same time.

The EPCIS provides standardized XML-based Capture & Query Interfaces to enable “Track & Trace” of products even in a global environment with a standardized interface, thereby increasing product visibility. The EPCIS serves as a hub for collecting EPC data for a company. In this disclosure, for this purpose, a module for acquiring event information (Track Data Collector), an event information interpretation module for interpreting the event information (Track Data Analyzer), and/or a module for reflecting the interpreted results on a supply chain scenario of a specific product (EPCIS Scenario Builder) among a plurality of supply chain scenarios (EPCIS Track Documents) may be prepared.

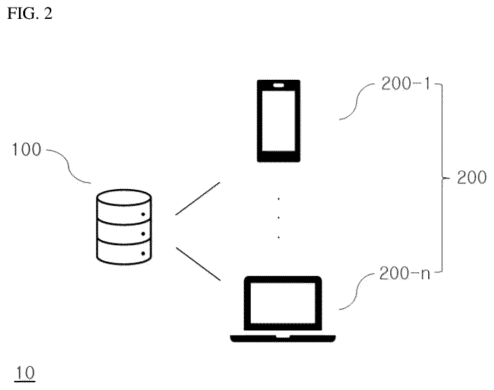

FIG. 2 is a diagram showing a network structure of a system for tracking supply chain transaction information based on the EPC global network according to an embodiment of the present disclosure.

Referring to FIG. 2, a system 10 for tracking supply chain transaction information (hereinafter referred to as a “tracking system”) may include a device 100 for tracking supply chain transaction information (hereinafter referred to as a “tracking device”) and at least one player terminal 200. Here, the tracking device 100 corresponds to the Supply Chain Visualizer of FIG. 1.

First, the tracking device 100 acquires at least one piece of event information generated during a manufacturing or distribution process of a specific product from each of the at least one player terminal 200. Here, the event information includes at least one event input by the player terminal 200 corresponding to the manufacturing or distribution process while going through the manufacturing or distribution process.

That is, the tracking device 100 may acquire the event information by allowing the player terminal 200 of the manufacturing or distribution process to input at least one event that occurred during the manufacturing or distribution process through a separate platform (application or web page).

In addition, the tracking device 100 interprets the at least one piece of event information in conformity with a standard for predetermined supply chain transaction information and reflects the at least one event information on a supply chain scenario relating to a specific product among a plurality of supply chain scenarios, thereby generating a map for tracking the manufacturing or distribution process of the specific product.

Meanwhile, when event information is acquired from each player terminal 200, the tracking device 100 may generate an electronic identification code including the event information. Specifically, the electronic identification code is generated based on event information acquired each time a specific product goes through a manufacturing or distribution process, and in this case, when there is at least one process prior to the manufacturing or distribution process, the electronic identification code includes not only event information for the manufacturing or distribution process but also at least one piece of event information for the process prior to the manufacturing or distribution process. specific product generated by the tracking device 100 or at least one piece of event information included in the map to provide a recent history (including manufacturing, processing, distribution, etc.) for the specific product. In other words, the tracking device 100 may provide a map pointed to by the electronic identification code or at least one piece of event information included in the map as a history.

Here, the electronic identification code may be generated in the form of at least one of an EPC, a quick response (QR) code, and a barcode, and a player, consumer, etc. may receive a production history of a specific product by scanning this electronic identification code. That is, when information about an electronic identification code corresponding to a specific product is acquired from a terminal possessed by a player, consumer, etc. (a player terminal, a consumer terminal, etc.), the tracking device 100 provides a map pointed to by the acquired information or at least one event information included in the map. In this case, information about the electronic identification code may be acquired through scanning or by manually inputting the information, and there is no limitation on the method of acquiring the information.

To this end, the tracking device 100 may provide a separate application or a platform such as a web page for providing such a supply chain transaction information tracking service, as well as an artificial intelligence-based pre-trained model.

Meanwhile, at least one player terminal 200 is a terminal possessed by each player involved (participating) in manufacturing or distribution of a specific product (a company, a user, a manager, a stakeholder, a person in charge, or the like), and each of player terminals 200-1, . . . , 200-n inputs and stores at least one event occurring in a manufacturing or distribution process corresponding to a corresponding player on the platform provided by the tracking device 100, thereby allowing event information to be automatically generated.

In addition, the at least one player terminal 200 may be an Ultra Mobile PC (UMPC), a workstation, a net-book, a PDA, a portable computer, a web tablet, a wireless phone, a mobile phone, a smart phone, a pad, a smart watch, a wearable terminal, an e-book, a portable multimedia player (PMP), a portable game console, a navigation device, a black box, a digital camera, another mobile communication terminal, etc., on which each player may install and execute a plurality of application programs (i.e., applications) desired by the player. That is, the at least one player terminal 200 may be provided in any of various forms, and the form in which the at least one player terminal 200 is provided is not limited.

Meanwhile, the tracking system 10 may further include at least one consumer terminal 300, specifically an electronic identification code scanner. Each consumer terminal 300-1, . . . , 300-n may scan the electronic identification code generated by the tracking device 100 to receive a map for a specific product corresponding thereto or at least one piece of event information included in the map on the basis of a preset template.

Specifically, a consumer who has purchased a specific product may check a production history thereof in a map for the specific product or at least one piece of event information included in the map visually displayed on a display based on a preset template through a platform provided by the tracking device 100, by scanning an electronic identification code attached to the specific product through a consumer terminal 300 possessed by the consumer.

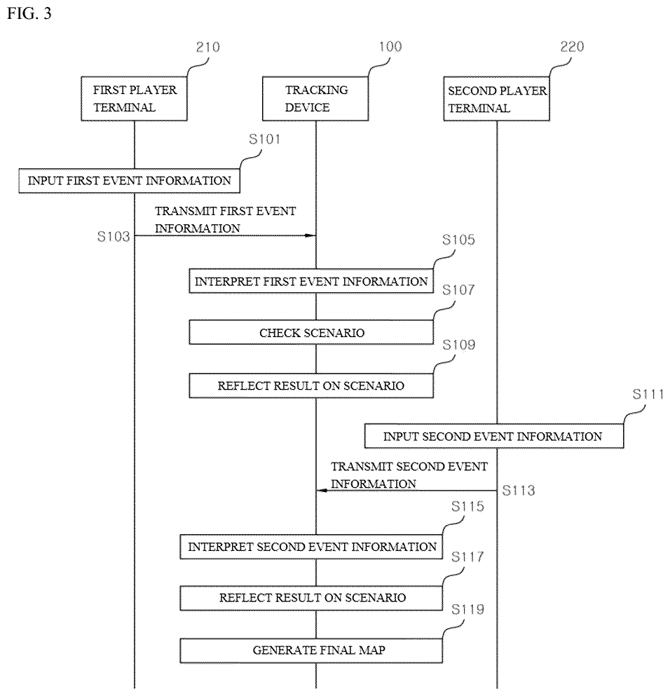

FIG. 3 is a flowchart showing an operation of the system for tracking supply chain transaction information according to an embodiment of the present disclosure, and is limited to a case where a map for a specific product produced through a first manufacturing process by a first player and a second manufacturing process by a second player is generated. In addition, it is assumed that the first player performing the first manufacturing process is the first consumer who purchased raw materials, and the second player performing the second manufacturing process is the second consumer who purchased intermediate materials manufactured by the first manufacturing process.

It should be noted that this is only one example for the convenience of description, and the numbers of player terminals and customer terminals and each step may be added or omitted depending on a series of production processes and the numbers of players and customers involved in each production process.

Referring to FIG. 3, when the production of a specific product starts and first event information including at least one event occurring in the first manufacturing process is input on the platform through a first player terminal 310 (S101), the first consumer who purchased the raw materials for the first manufacturing process transmits the input first event information to the tracking device 100 (S103).

Next, the tracking device 100 interprets the first event information received in operation S103 in conformity with a standard for predetermined supply chain transaction information (S105), checks a supply chain scenario relating to the specific product among a plurality of supply chain scenarios (S107), and then reflects the result interpreted in operation S105 on the checked supply chain scenario (S109).

Next, when second event information including at least one event occurring in the second manufacturing process is input on the platform through the second consumer terminal 220 (S111), the second consumer who purchased intermediate goods manufactured by the first manufacturing process for the second manufacturing process transmits the input second event information to the tracking device 100 (S113).

Next, the tracking device 100 interprets the second event information received in operation S113 in conformity with a standard for predetermined supply chain transaction information (S115), and reflects the result interpreted in operation S115 on the supply chain scenario relating to the specific product (S117).

Thus, as the entire production process of the specific product is performed, a scenario that reflects all interpreted results for event information of each manufacturing process is generated as a final map (S119).

Although not shown in FIG. 3, when performing steps S101 and S111, each of the first consumer terminal 310 and the second consumer terminal may receive event information by scanning an electronic identification code.

On the other hand, if the user terminal 300 according to an embodiment of the present disclosure is implemented as an electronic identification code reader (referred to as an electronic identification code scanner) that receives event information by scanning an electronic identification code, the user terminal 300 may process the received event information to comply with a predetermined standard for supply chain transaction information and provide the event information to the tracking device 100.

A configuration of an electronic identification code reader 300 will be described below, which processes event information to comply with a predetermined standard for supply chain transaction information and provides the event information to the tracking device 100.

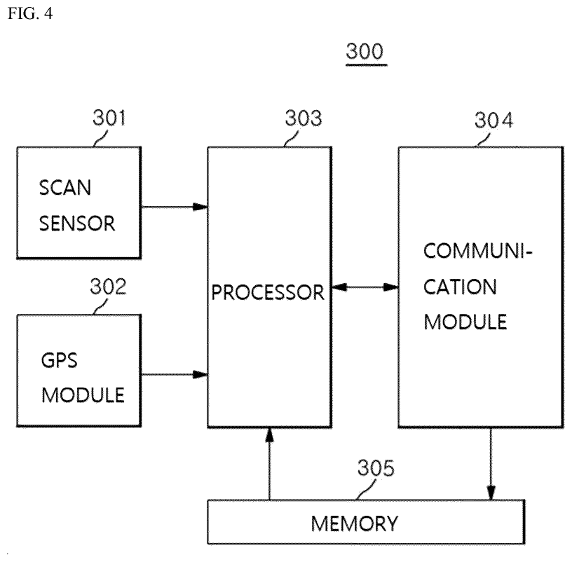

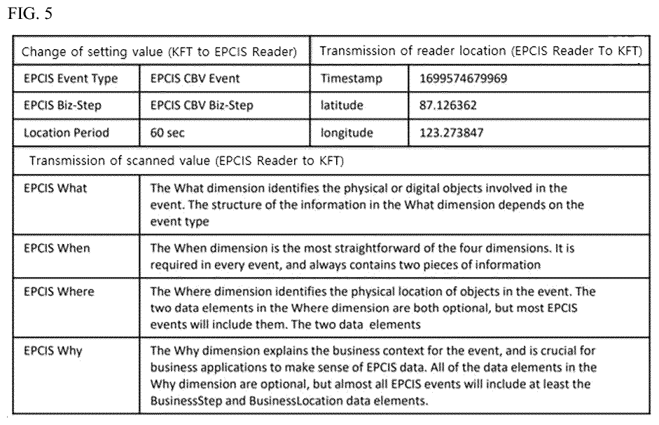

FIG. 4 is a diagram illustrating a configuration of an electronic identification code scanner for tracking supply chain transaction information according to an embodiment of the present disclosure, and FIG. 5 is a diagram for describing a standardized format (template) for supply chain transaction information according to an embodiment of the present disclosure.

Referring to FIG. 4, an electronic identification code scanner 300 for tracking supply chain transaction information according to an embodiment of the present disclosure may include a scan sensor 301, a GPS module 302, a processor 303, a communication module 304, and a memory 305.

The scan sensor 301 may scan an electronic identification code provided for a specified product. To this end, the scan sensor 301 may scan an electronic identification code according to various known methods. The scan sensor 301 according to an embodiment of the present disclosure may employ at least one of the following methods: a laser scan, which uses laser light to scan an electronic identification code, an imaging scan, which uses a camera to capture and interpret the image of an electronic identification code, and a CCD scan, which uses a charge-coupled device (CCD) sensor to scan an electronic identification code.

If the electronic identification code is implemented as GTIN (Global Trade Item Number), GLN (Global Location Number), SSCC (Serial Shipping Container Code), or the like according to the GS1 standard, the scan sensor 301 according to an embodiment of the present disclosure may perform a 1D (one-dimensional) barcode scanning. As used herein, 1D barcode scanning may refer to scanning a barcode that consists of a series of vertical lines.

In contrast, if the electronic identification code is implemented as a GS1DataMatrix or GS1QRCode, or the like, in accordance with GS1 standards, the scan sensor 301 according to an embodiment of the present disclosure may perform 2D barcode scanning. As used herein, 2D barcode scanning refers to scanning a barcode capable of containing data in both vertical and horizontal orientations, allowing more information to be scanned than the 1D barcode scanning.

The GPS module 302 may receive GPS information. Here, the GPS information is satellite signals received via a GPS antenna, which may include information on location and transmission time for each satellite. Based on the satellite signals received from a plurality of different satellites, the GPS module 302 may obtain location information and time information of the electronic identification code scanner 300 on which the GPS module 302 is mounted.

The GPS module 302 may include a GPS antenna for receiving GPS signals, an RF receiver for processing received signals, a signal processing unit for processing received digital data to extract information on the location and transmission time of each satellite, and a location estimation unit for calculating a location where the GPS module 302 is mounted based on the extracted information.

The processor 303 may determine event information corresponding to the scanned electronic identification code, and convert the event information into a predetermined standardized format for supply chain transaction information using the received GPS information. Here, the standard for supply chain transaction information is a convention based on a predetermined grammar, and may include EPCIS for efficiently tracking and sharing product and logistics information. Further, the event information may include at least one of the first information on the received product, the second information on the shipped product, and the third information on actions that occur between warehousing and shipping, based on business steps in the supply chain of the product.

Specifically, the processor 303 may convert the event information into a standardized format for supply chain transaction information, which includes object information, time information, location information, and purpose information. Referring to FIG. 5, the object information, disclosed as an EPCIS What, may include information identifying a physical or digital object related to an event. The structure of the object information may vary depending on a type of the event.

The time information, disclosed as EPCIS When, is the simplest of the four pieces of information included in the standardized format for supply chain transaction information and may be required for all events. Specifically, the time information may include Event Time information and Event Time Zone Offset information.

The location information, disclosed as EPCIS Where, may identify the physical location of an object in an event. In this case, the location information may include a Read Point, which indicates the physical location of the electronic identification code scanner 300 that has scanned the electronic identification code, and a Business Location, which includes a business place where a business activity occurred. These two pieces of data are optional, but most EPCIS events may include them.

Finally, the purpose information, disclosed as EPCIS Why, may provide business context for an event, such as information describing the cause or motivation for the occurrence of the event. The purpose information may be important for business applications to understand EPCIS data.

Referring again to FIG. 4, the processor 303 may obtain object information from the identified event information, and time information and location information from the GPS information. Further, the processor 303 may obtain the purpose information from the pre-stored logistics environment information. Based on the obtained object information, time information, location information, and purpose information, the processor 303 may convert the event information into a standardized format for supply chain transaction information.

The communication module 304 may transmit the event information converted to the standardized format to the tracking device 100. In addition, the tracking device 100 which has received the event information may interpret the event information converted to the standardized format and reflect the at least one event information on a supply chain scenario relating to a specific product among a plurality of supply chain scenarios, thereby generating a map for tracking the manufacturing or distribution process of the specific product.

To this end, the communication module 304 may communicate not only with the tracking device 100, but also with other devices such as the player terminal 200, and may transmit and receive wireless signals in communication networks according to wireless Internet technologies.

Examples of wireless Internet technologies include Wireless LAN (WLAN), Wireless-Fidelity (Wi-Fi), Wi-Fi Direct, Digital Living Network Alliance (DLNA), WiBro, World Interoperability for Microwave Access (WiMAX), High Speed Downlink Packet Access (HSDPA), High Speed Uplink Packet Access (HSUPA), Long Term Evolution (LTE), LTE-Advanced (LTE-A), etc., and the tracking device 100 transmits and receives data based on at least one wireless Internet technology, including Internet technologies not listed above.

Wireless Internet technologies for short range communication include Bluetooth™, RFID, Infrared Data Association (IrDA), Ultra Wideband (UWB), ZigBee, Near Field Communication (NFC), Wi-Fi, Wi-Fi Direct, and Wireless Universal Serial Bus (USB) technologies, and short range communications may be supported using at least one of these technologies. These short range wireless communication networks may support wireless communication between the tracking device 100 and at least one terminal. Here, the short range wireless communication network may be a short range wireless personal area network (WPAN).

Further, the communication module 304 may receive logistics environment information from the tracking device 100. As used herein, the logistics environment information may refer to configuration (settings information) of the electronic identification code scanner 300 that corresponds to a situation in a logistics environment. Specifically, the logistics environment information may function to preset which event action the electronic identification code scanner 300 is to perform by selecting an item in the EPCIS CVB.

The logistics environment information, according to an embodiment of the present disclosure, may include an EPCIS EVENT TYPE, an EPCIS Biz-Step, and a Location Period.

An event type may represent a change in a specific variable or state. Such a event may be used to detect and process a specific behavior or a change in state. In particular, a Core Business Vocabulary (CBV) event represents an event that indicates a change in a variable that belongs to the CBV, where a CBV may refer to a companion standard that provides definitions of data values that may be used to fill data structures defined in the EPCIS standard. In other words, CBV events may serve to detect and notify changes in critical business variables.

The business step may represent a specific step or state in a business process. For example, in the process of producing a specific product in manufacturing, the business step may represent the stages of “manufacturing started,” “quality checking,” “production completed,” and so on.

The location period may refer to a period of time during which an item stays at a specific location. Specifically, the location period may represent collecting data from a specific area, device, or location and observing the data over a time interval. In this case, the data may be updated or monitored periodically at the location where the location period is set.

The processor 303 may obtain purpose information based on the logistics environment information described above. The processor 303, according to an embodiment of the present disclosure, may trigger a change in the data by using a event type in the logistics environment information. Specifically, the processor 303 may set up a monitor event and generate an event when a certain variable value is changed, and may obtain the purpose information by utilizing the type of the event.

Further, the processor 303 may obtain the purpose information using business steps that represent steps or states of a business process among the logistics environment information. Since a business step may generate an event based on a specific state change in the business process, the processor 303 may obtain the purpose information by using the event, the purpose information allowing the processor 303 to track at which business process step the change in data has occurred.

Further, the processor 303 may obtain the purpose information for tracking the change in data by utilizing the location period during which the processor 303 is able to periodically observe data and generate an event. Specifically, the location period may be used to track when data has changed at a specific location, from which the processor 303 may obtain the purpose information.

Based on the purpose information, the processor 303 according to an embodiment of the present disclosure may generate a business step (biz-step) based event whenever a value of a variable according to the event type changes according to a predetermined condition, and obtain purpose information about at which step the change in the value of the variable has occurred for the generated event. For example, the processor 303 may monitor the value of the variable using a monitor event in a specific business process and generate an event with information about the business step (biz-step) whenever the value of a corresponding variable changes according to a certain condition. The generated event may include purpose information about at which step the change in data has occurred.

The communication module 304 may receive and store the logistics environment information in the memory 305. The memory 305 may provide the pre-stored logistics environment information at the request of the processor 303, and the processor 303 may obtain the purpose information from the logistics environment information.

Additionally, the memory 305 may store a plurality of application programs or applications running on the electronic identification code scanner 300, data, and instructions for operating the electronic identification code scanner 300. At least some of these applications may be downloaded from an external server via wireless communication. The application may be installed on the electronic identification code scanner 300 by being stored in the memory 305, and may be driven to perform an action (or function) by the at least one processor 303 via the processor 303 stored in the memory 305.

Meanwhile, the memory 305 may be provided as at least one memory, and may include at least one type of storage medium among a flash memory type medium, a hard disk type medium, a multimedia card micro type medium, a card type memory (e.g., an SD or XD memory, etc.), a magnetic memory of a random access memory (RAM), a static RAM (SRAM), a read-only memory (ROM), an electrically erasable programmable ROM (EEPROM), a programmable ROM (PROM), a magnetic disk, and an optical disc. In addition, the memory may store information temporarily, permanently, or semi-permanently, and may be provided as a built-in or removable type memory.

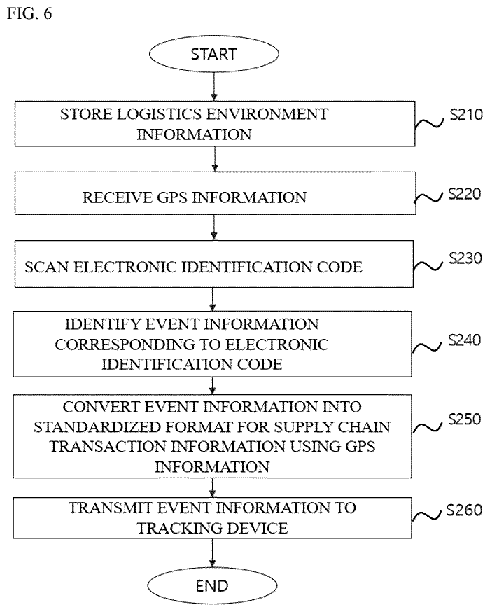

FIG. 6 is a flow chart of a control method of an electronic identification code scanner according to an embodiment of the present disclosure.

Referring to FIG. 6, the electronic identification code scanner 300 may store logistics environment information (S210). Specifically, the electronic identification code scanner 300 may receive logistics environment information from the tracking device 100 via the communication module 304 and store the logistics environment information in the memory 305 in advance.

The electronic identification code scanner 300 may then receive GPS information (S220). Further, the electronic identification code scanner 300 may scan the electronic identification code of an item (S230). Although it is illustrated that S220 and S230 are performed sequentially, S220 and S230 may be performed in reverse order or simultaneously.

After scanning the electronic identification code, the electronic identification code scanner 300 may identify event information corresponding to the scanned electronic identification code (S240). The electronic identification code scanner 300 may then use the GPS information to convert the event information into a standardized format for supply chain transaction information (S250). Specifically, the processor 303 of the electronic identification code scanner 300 may convert the identified event information into a standardized format for supply chain transaction information that includes object information, time information, location information, and purpose information.

In this case, the processor 303 may obtain object information from the identified event information, obtain time information and location information from the GPS information, and obtain purpose information from pre-stored logistics environment information. The purpose information may include at least one of a Business step, which represents a specific activity or task in a business process; a Disposition, which represents a disposition or decision about an asset or resource; a Business Transaction List, which represents a list of transactions that have occurred in the business; a Source List, which represents a list associated with resources, materials, or suppliers needed in the business; and a Destination List, which represents a location or destination to which a product, service, or resource is being moved or delivered in the business process.

Finally, the electronic identification code scanner 300 may transmit the event information converted to the standardized format to the tracking device 100 (S260). Thereby, the tracking device 100 may interpret the event information converted to the standardized format, identify a supply chain scenario associated with a specific product among a plurality of stored supply chain scenarios, and generate a map for the specific product by reflecting the interpreted results on the identified supply chain scenario.

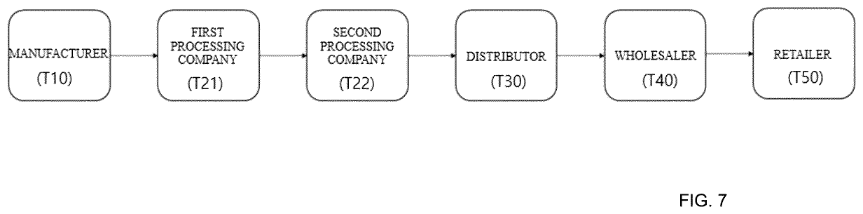

FIG. 7 is a diagram showing an example of a supply chain scenario according to an embodiment of the present disclosure.

Prior to description, the supply chain scenario forms the supply chain by sequentially arranging ordering, processing (manufacturing), distribution, and sales (wholesale, retail) operations involved in the production process of the specific product.

Referring to FIG. 7, an example of a supply chain scenario that includes a manufacturer T10, a first processing company T21, a second processing company T22, a distributor T30, a wholesaler T40, and a retailer T50 as players involved in a production process of a specific product is shown.

Specifically, primary processing may be performed by the first processing company T21 based on ordering information of the manufacturer T10, and the primarily processed product may be delivered to the second processing company T22 for secondary processing, delivered to the wholesaler T40 through the distributor T30, and delivered from the wholesaler T40 to the retailer T50. That is, a specific product is produced by sequentially passing through each player, i.e., each company that constitutes the supply chain scenario. In this case, event information may be entered on the platform by each company as the product passes through each company, and accordingly, an electronic identification code may also be generated.

Thus, according to the above-described electronic identification code scanner and the control method thereof, event information obtained by scanning an electronic identification code may be converted into a standardized format for supply chain transaction information without any additional analysis or interpretation. In particular, by simply setting the scanner to be suitable for a logistics environment, the event information may be easily converted into a standardized format for that context.

According to the aspects of the present disclosure, various types of information occurring in the manufacturing and/or distribution process of a product are recorded and managed as a history so that not only players involved in the manufacturing and/or distribution process but also consumers consuming the product can quickly and accurately track the history.

Each step included in the above-described control method of the electronic identification code scanner may be implemented with a computer program programmed to perform these steps. The program may include code coded in a computer language such as C, C++, JAVA, or machine language that can be read by a processor (CPU) of a computer through a device interface of the computer in order to cause the computer to read the program and execute the methods implemented as the program. The code may include functional code related to functions that define functions necessary for executing the methods, and may include control code relating to an execution procedure required to cause the processor of the computer to execute the above functions according to a predetermined procedure. In addition, such code may further include code related to memory reference regarding at which location (address) of an internal or external memory of the computer additional information or media required to cause the processor of the computer to execute the above functions should be referenced. In addition, when the processor of the computer needs to communicate with any other remote computer or server, etc., in order to cause the above functions to be executed, the code may further include communication-related code regarding how to communicate with any other remote computer or server, etc., using a communication module of the computer, and what information or media should be transmitted and received during the communication.

The storage medium is a medium that stores data semi-permanently and can be read by a device, rather than a medium that stores data for a short period of time, such as a register, cache, or memory. Specifically, examples of the storage medium include, but are not limited to, a ROM, a RAM, a CD-ROM, a magnetic tape, a floppy disk, and an optical data storage device. That is, the program may be stored in various storage media on various servers that the computer can access or in various storage media on the user's computer. In addition, the medium may be distributed to computer systems connected to a network and store computer-readable code in a distributed manner.

The steps of the method or algorithm described in relation to embodiments of the present disclosure may be implemented directly on hardware, implemented as a software module executed by hardware, or implemented by a combination thereof. The software module may reside in a RAM, a ROM, an EPROM, an EEPROM, a flash memory, a hard disk, a removable disk, a CD-ROM, or any other form of computer-readable recording medium well known in the art to which the present disclosure pertains.

According to the aspects of the present disclosure, it is possible to convert event information obtained by scanning an electronic identification code into a standardized format for supply chain transaction information without a separate analysis or interpretation process. In particular, event information may be easily converted into a standardized format corresponding to a corresponding situation (context) by simply setting the scanner to be suitable for a logistics environment.

According to the aspects of the present disclosure, various types of information occurring in the manufacturing and/or distribution process of a product are recorded and managed as a history so that not only players involved in the manufacturing and/or distribution process but also consumers consuming the product can quickly and accurately track the history.

The effects of the present disclosure are not limited to the effects mentioned above, and other effects not mentioned will be clearly understood by those skilled in the art from the description above.

Although embodiments of the present disclosure have been described above with reference to the accompanying drawings, those skilled in the art to which the present disclosure pertains will understand that the present disclosure may be implemented in other specific forms without changing the technical spirit or essential characteristics thereof. Therefore, it should be understood that the embodiments described above are exemplary in all respects and not restrictive.

What is claimed is:

1. An electronic identification code scanner comprising:
a memory configured to store logistics environment information in advance;
a GPS module configured to receive GPS information;
a scan sensor configured to scan an electronic identification code;
a processor configured to identify event information corresponding to the scanned electronic identification code and convert the event information into a predetermined standardized format for supply chain transaction information, the standardized format including object information, time information, location information and purpose information; and
a communication module configured to transmit the event information having the standardized format,
wherein the logistics environment information includes an event type (EPCIS EVENT TYPE) indicating a change in a specific variable or state, a business step (EPCIS Biz-Step) indicating a specific step or state in a business process, and a location period indicating a period of time during which a product stays at a specific location, and
wherein the processor is configured to obtain the object information from the identified event information, obtain the time information and the location information from the GPS information, and generate an event indicating a change in a variable from a Core Business Vocabulary (CBV), based on the business step whenever a value of the variable changes according to a predetermined condition, using the business step indicating the specific step or state in the business process among the logistics environment information to obtain the purpose information indicating at which business step in the business process the value of the variable has changed for the generated event, the value of the variable being determined by the event type.

2. The electronic identification code scanner of claim 1, wherein the purpose information includes at least one of a Business step representing a specific activity or task in a business process; a Disposition representing a disposition or decision about an asset or resource; a Business Transaction List representing a list of transactions that have occurred in the business; a Source List representing a list associated with resources, materials, or suppliers needed in the business; and a Destination List representing a location or destination to which a product, service, or resource is being moved or delivered in the business process.

3. The electronic identification code scanner of claim 1, wherein the processor is configured to transmit the event information, which has converted into the standardized format to the tracking device by inputting the event information into a separate platform or app for providing a supply chain transaction information tracking service, and
wherein the tracking device is configured to receive the event information and generate a map for tracking a manufacturing or distribution process for a specific product by reflecting the event information in a supply chain scenario related to the specific product among a plurality of supply chain scenarios.

4. A control method of an electronic identification code scanner, the control method being performed by the electronic identification code scanner, the control method comprising:
storing, in a memory, logistics environment information including an event type (EPCIS EVENT TYPE) indicating a change in a specific variable or state, a business step (EPCIS Biz-Step) indicating a specific step or state in a business process, and a location period indicating a period of time during which a product stays at a specific location;
receiving GPS information;
scanning an electronic identification code;
identifying event information corresponding to the scanned electronic identification code;
converting the event information into a predetermined standardized format for supply chain transaction information, the standardized format including object information, time information, location information and purpose information; and
transmitting the event information having the standardized format,
wherein the converting of the event information into the predetermined standardized format for supply chain transaction information includes:
obtaining the object information from the identified event information;
obtaining the time information and the location information from the GPS information; and
generating an event indicating a change in a variable from a Core Business Vocabulary (CBV), based on the business step whenever a value of the variable changes according to a predetermined condition, using the business step indicating the specific step or state in the business process among the logistics environment information to obtain the purpose information indicating at which business step in the business process the value of the variable has changed for the generated event, the value of the variable being determined by the event type.

5. The control method of claim 4, wherein the purpose information includes at least one of a Business step representing a specific activity or task in a business process; a Disposition representing a disposition or decision about an asset or resource; a Business Transaction List representing a list of transactions that have occurred in the business; a Source List representing a list associated with resources, materials, or suppliers needed in the business; and a Destination List representing a location or destination to which a product, service, or resource is being moved or delivered in the business process.

6. The control method of claim 4, further comprising:
transmitting the event information, which has converted into the standardized format to the tracking device by inputting the event information into a separate platform or app for providing a supply chain transaction information tracking service,
wherein the tracking device receives the event information and generates a map for tracking a manufacturing or distribution process for a specific product by reflecting the event information in a supply chain scenario related to the specific product among a plurality of supply chain scenarios.

7. A computer program that is stored in a computer-readable recording medium for causing the control method according to claim 4 to be executed by being combined with a computer which is hardware.
